(19) United States
(12) Patent Application Publication
(10) Pub. No.: US 2024/0119293 A1
(43) Pub. Date: Apr. 11, 2024

(54) BUILDING GENERALIZED MACHINE LEARNING MODELS FROM MACHINE LEARNING MODEL EXPLANATIONS

(71) Applicant: Cypress Semiconductor Corporation, San Jose, CA (US)

(72) Inventors: Niall Lyons, Irvine, CA (US); Arnab Neelim Mazumder, Arbutus, MD (US); Anand Dubey, Munchen (DE); Ashutosh Pandey, Irvine, CA (US); Avik Santra, Irvine, CA (US)

(73) Assignee: Cypress Semiconductor Corporation, San Jose, CA (US)

(21) Appl. No.: 18/178,223

(22) Filed: Mar. 3, 2023

Related U.S. Application Data
(60) Provisional application No. 63/413,725, filed on Oct. 6, 2022.

(51) Int. Cl. G06N 3/0895

(52) U.S. Cl. CPC G06N 3/0895

(57) ABSTRACT

A system includes a memory and a processing device, operatively coupled to the memory, to receive, from a client device via a user interface, input data comprising an initial version of a machine learning model, initialize an operating mode of the user interface for machine learning model building, and generate an enhanced version of the machine learning model in accordance with the operating mode.

### RELATED APPLICATIONS

This application claims the benefit of U.S. Provisional Application No. 63/413,725, filed Oct. 6, 2022, the entire contents of which are incorporated herein by reference.

### TECHNICAL FIELD

The present disclosure pertains to machine learning models, and more specifically, to building generalized machine learning models from machine learning model explanations.

### BACKGROUND

Machine learning models can be used to make predictions from a set of input data. Input data can include image data, audio data, time series data, etc. For example, a machine learning model can be a classification model that predicts a class. A machine learning model can be trained using training data to make predictions. Examples of machine learning models include supervised learning models that are trained with labeled training data, unsupervised learning models that are trained without labeled training data, and semi-supervised learning models that are trained using a combination of labeled training data and unlabeled training data. Examples of machine learning models include neural networks (e.g., deep learning models), decision trees, support vector machines (SVMs), regression models, Bayesian models, etc.

### BRIEF DESCRIPTION OF THE DRAWINGS

The disclosure is illustrated by way of example, and not of limitation, in the figures of the accompanying drawings.

FIG. 1 is a block diagram of an example computer system that can be used to build generalized machine learning models from machine learning model explanations, in accordance with some embodiments.

FIG. 2A is a block diagram of an example system including an embedded stack for machine learning applications, according to some embodiments.

FIG. 2B is a block diagram of an example system to implement an embedded machine learning development flow, according to some embodiments.

FIG. 3 is a block diagram of example user interface modes for building generalized machine learning models from machine learning model explanations, according to some embodiments.

FIG. 4 is a block diagram of an example implementation of a user interface mode for building generalized machine learning models from machine learning model explanations, according to some embodiments.

FIG. 5 is a block diagram of an example system for building generalized machine learning models from machine learning model explanations, according to some embodiments.

FIGS. 6-7 are flow diagrams of example methods of building generalized machine learning models from machine learning model explanations, according to some embodiments.

FIG. 8 is a flow diagram of an example method of retraining a machine learning model using incremental learning, according to some embodiments.

FIG. 9 is a block diagram of an example computer system in which embodiments of the present disclosure can operate.

### DETAILED DESCRIPTION

Embedded systems can employ the use of machine learning models in various applications to enable the embedded systems to make predictions that can be used in decision making. For example, a machine learning model can include a neural network. A neural network is a computational model that implements a multitude of connected nodes called “artificial neurons,” such that each artificial neuron processes one or more input signals (including a bias signal) and transmits the output signal to one or more neighboring artificial neurons. The output of an artificial neuron can be computed by applying its activation function to a linear and/or nonlinear combination of its inputs. A neural network can be trained by processing examples (e.g., training data sets) to perform feature extraction, regression, and/or classification tasks without being programmed with any task-specific rules. Computing devices, such as automotive, wearable, hand-held, metering, appliance integrated, and the like, often rely on the use of machine learning models in making and improving predictions for embedded systems.

In machine learning, a feature is a measurable characteristic of an object. For example, a feature can be a numerical representation of an object. A set of features can be used to represent an object. In some embodiments, a set of features is a feature embedding within a feature space. The feature space can be a lower-dimensional space. For example, a set of features can be defined by a feature vector within a feature space. Each feature of a set of features can be assigned a respective feature weight. Each feature weight represents an importance of the respective feature in making a prediction using a corresponding machine learning model (e.g., relative prediction).

It may be the case that the features are sub-optimal and can yield prediction errors (e.g., misclassifications). As an illustrative example, assume that a system attempts to use a machine learning model to classify an image of a Czech wolfdog. The set of features can include a first feature representing the body of the dog in the image, a second feature representing the tail of the dog in the image, a third feature representing the head of the dog in the image (e.g., face and ears), and a fourth feature representing the legs of the dog in the image. Each feature of the set of features can be assigned with a respective feature weight. However, if the feature weights are sub-optimal, then the system may misclassify the image as an Eskimo dog.

However, machine learning models, such as deep learning models, can be complex in nature. For example, deep neural network layers can be representative of latent features. Due to the complexity of such machine learning models, a user may only know the input data and the output prediction of a machine learning model, and may not be able to determine how to modify feature weights to improve the accuracy of the output prediction (e.g., reduce misclassifications).

To address at least these drawbacks, the embodiments described herein provide for systems and methods to build generalized machine learning models from machine learning model explanations. For example, building a generalized machine learning model can include receiving an input signal. In some embodiments, receiving the input signal includes receiving raw data from a data source, and preprocessing the raw data to obtain the input signal. The raw data can include at least one of audio data, image data, audiovisual data, time series data, etc. For example, the raw data can include audio data, and the input signal can include processed audio data (e.g., a spectrogram). As another example, the raw data can include image data, and the input signal can include processed image data.

Building the generalized machine learning model can further include using a machine learning model to generate a prediction based on the input signal, and generating an explanation of the prediction. An explanation can be used to interpret a decisions made by a machine learning model. For example, an explanation can provide an indication of feature importance and interpretable insight into how the machine learning model generated the prediction. An explanation can include information indicating which feature(s) were used by the machine learning model to make a prediction, as well as which feature(s) were considered to be more important than other features by the machine learning model for making the prediction. For example, an explanation can be included in an interactive object that can be modified in response to user feedback (e.g., via a graphical user interface (GUI)). Moreover, the process of building a generalized machine learning model can use the feature-importance information to improve the generalized machine learning model.

In some embodiments, an explanation is a local interpretable model-agnostic explanation (LIME). LIME creates a local linear approximation of the model's behavior around a given instance, and uses this approximation to compute the importance of each feature for the prediction. The resulting weights can be used to adjust a loss function, giving more importance to features that have a larger impact on the prediction.

In some embodiments, an explanation is a visual explanation. For example, the visual explanation can be a LIME-based visual explanation. A visual explanation can include a visual representation of the feature(s) considered by the machine learning model in making the prediction. For example, a visual explanation can be generated by assigning, to one or more regions of the input signal, one or more respective feature weights. Illustratively, if the input signal is a spectrogram, then the visual explanation can be generated by segmenting the spectrogram into one or more segments, and assigning a respective feature weight to each segment. Similarly, if the input signal is an image, then the visual explanation can be generated by segmenting the image into one or more segments, and assigning a respective feature weight to each segment.

In some embodiments, building the generalized machine learning model further includes obtaining a set of feature weights for an incorrection prediction based on the explanation. Obtaining the set of feature weights can include obtaining a current set of feature weights, and updating a previous set of feature weights with the current set of feature weights to address the incorrect prediction. That is, obtaining the set of feature weights can include modifying the previous set of feature weights. Accordingly, obtaining the set of feature weights can improve the ability of the machine learning model to make predictions.

In some embodiments, obtaining the set of feature weights includes generating the set of feature weights. These embodiments can be used to automatically determine a set of feature weights that can yield improved prediction accuracy, which can provide less advanced users (i.e., laypeople) with a tool for improving machine learning model performance. In some embodiments, obtaining the set of feature weights includes sending the explanation to a client device, receiving user input after sending the explanation to the client device, and obtaining the set of feature weights based on the user input (e.g., updating the previous set of feature weights). More specifically, the explanation sent to the client device can enable a user to modify the set of features and/or feature importance used by a machine learning model to make a prediction without requiring a deeper understanding of the underlying structure of the machine learning model. For example, the user input can include a set of ground truth features, with each ground truth feature having a corresponding feature weight. These embodiments can enable more advanced users to provide a customized set of features and/or adjust a set of automatically generated features for improving machine learning model performance.

Building the generalized machine learning model can further include training (e.g., retraining) the generalized machine learning model using the set of feature weights. The generalized machine learning model can be trained using weighted loss in which only incorrectly predicted samples are included in the training set during retraining. Training the generalized machine learning model using weighted loss includes using a custom loss that assigns a weighting factor to the incorrectly predicted samples being added to the training set. The weighting factor can be derived from the difference between true explanations and predicted explanations.

A system described herein can support a user interface (UI) that enables a set of operating modes. In some embodiments, the UI is a GUI. The UI can enable a user to better under how a machine learning model works, which can be used to improve machine learning model performance and/or improve decision making based on machine learning model predictions. Illustratively, a doctor may use the UI to help diagnose medical conditions based on patient symptoms and test results. By using UI, the doctor can better understand the reasons behind the machine learning model predictions and make more informed decisions about the best course of treatment for the patient. Additionally, it can be useful for doctors in monitoring and managing chronic conditions, such as diabetes or heart disease where doctors can identify patterns and trends in a patient's data that may not be immediately apparent, which can help them provide more effective care. The UI can improve efficiency (e.g., by ensuring that a user can complete tasks quickly and easily with reduced confusion), satisfaction, flexibility (e.g., enable a user to adapt to different situations and to use the system in a variety of ways), and accessibility (e.g., users with different abilities and/or needs can use the system easily and effectively).

For example, the set of operating modes can include a first mode (“basic mode”). The basic mode allows a user to retrain a machine learning model. The basic mode can allow a user to include or remove incorrectly classified data (e.g., image data) based on their label, while building a visual representation of what is happening in the machine learning model. Visual understanding can help make complex data more understandable and interpretable to humans. It is possible to visually represent data in a way that is easy for the user to comprehend, which can help the user better understand the decisions and predictions made by the machine learning model. Additionally, visual graphs can help identify patterns and trends in data that may not be immediately apparent when looking at raw numbers, which can be valuable in understanding how the machine learning model is making decisions and in improving its performance.

For example, when operating in the basic mode, the system can receive, from a client device, a selection of a label, and send an explanation to the client device corresponding to the label. For example, if the label is “Czech wolfdog”, then the explanation can be an explanation corresponding to Czech wolfdog. The client device may be unable to modify the features and/or feature weights used by the machine learning model for the label. However, the client device may have the option to modify training data based on the explanation (e.g., remove and/or edit training data). Thus, the system can receive modified training data from the client device to improve machine learning model performance and prediction accuracy (e.g., reduce misclassification).

The set of operating modes can further include a second mode (“advanced mode”). In the advanced mode, the user may choose and demonstrate the characteristics of misclassified images that the model should be learning. The advanced mode can support advanced techniques that go beyond basic data visualization and machine learning model predictions. Some examples of these advanced techniques include methods that help identify which features of the input data are most important in influencing the predictions of the machine learning model, methods that provide alternative scenarios and show how the machine learning model predictions would change if certain features of the input data were different, methods to determine how sensitive the machine learning model predictions are to changes in the input data, and methods to conduct machine learning model introspection (i.e., examining the internal workings of the machine learning model to understand how it processes data and makes predictions). Accordingly, the advanced mode can help provide a user with a more detailed and nuanced explanation of how a machine learning model works, which can be valuable for understanding machine learning model behavior and improving machine learning model performance.

For example, when operating in the advanced mode, the system can support the same functionality as the basic mode (e.g., receive a selection of a label and send an explanation to the client device corresponding to the label), as well as provide functionality to modify the features and/or feature weights used by the machine learning model for the label. For example, when operating in the advanced mode, the system can obtain a set of features from a client device based on user input, as described above. For example, the client device can modify the previous set of features and/or feature weights used by the machine learning model for the label. The user input can include a set of ground truth features, where each ground truth feature has a corresponding feature weight. Moreover, when operating in the advanced mode, the system can automatically exclude or keep data to maintain data proportions and/or define important features for feature weighting.

The set of operating modes can further include a third mode (“query mode”). The query mode enables the user to upload images and query and display certain aspects of those images. One advantage of this mode is that it can provide more intuitive and human-understandable explanations of the model's predictions. Because humans are highly visual, being able to see the input images that the model is making predictions about can help make the explanations more relatable and understandable. Additionally, querying images can allow users to see the specific details of an image that the model is using to make its predictions, which can provide valuable insight into how the model is making decisions. This can be particularly useful for identifying any potential biases or errors in the model's predictions.

For example, when operating in the query mode, the system can receive an image from a client device, train a machine learning model using the image (e.g., on-the-fly training), and perform at least one action based on the training. Additionally, the system can receive one or more queries that can be used to refine the training process. For example, performing the at least one action can include defining a set of features for the image. As another example, performing the at least one action can further include creating an analysis report based on feature weight and label importance.

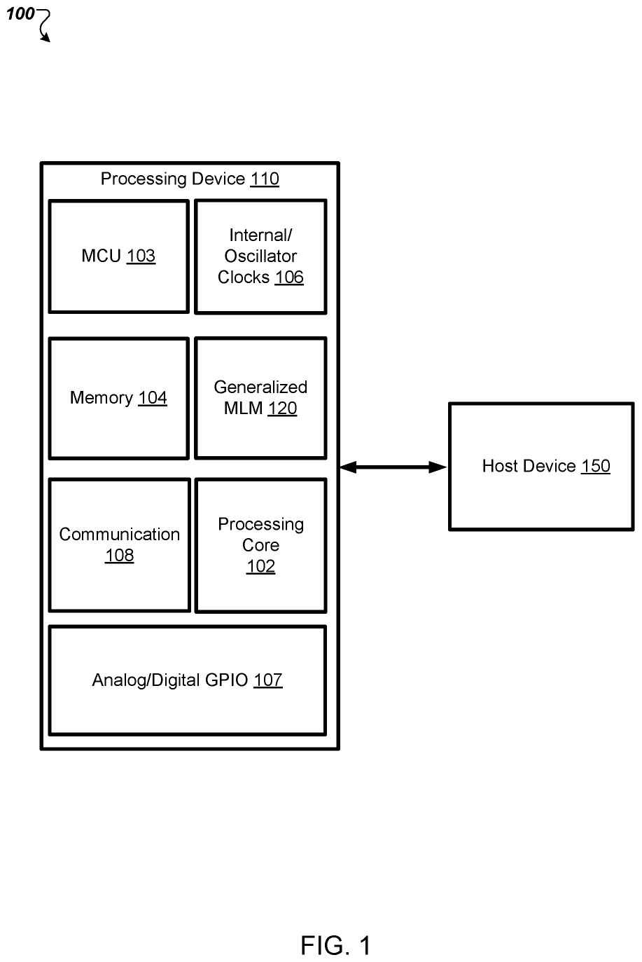

During the advanced mode and/or the query mode, the system can build a generalized machine learning model using the method described above. For example, in the Czech wolfdog example described above, the system can optimize the set of feature weights to force the machine learning model to recognize the image as a Czech wolfdog. For example, since the system can determine that the head and the tail are more important than the body and the legs for identifying a Czech wolfdog (e.g., automatically or by receiving input from a client device), the system can build a generalized machine learning model (e.g., retraining the machine learning model) using a set of feature weights in which the second and third features corresponding to the head and tail can have higher feature weights relative to the first and fourth features corresponding to the body and legs. Further details regarding generating explanations and building generalized models will be described in further detail below with reference to FIGS. 1-7.

Embodiments described herein can improve the performance of various applications performed by devices that implement activity recognition, such as smart home applications, healthcare monitoring applications, human-machine interface system applications, etc. Examples of devices that may use implement activity recognition may include, without limitation, automobiles, home appliances (e.g., refrigerators, washing machines, etc.), personal computers (e.g., laptop computers, notebook computers, etc.), mobile computing devices (e.g., tablets, tablet computers, e-reader devices, etc.), mobile communication devices (e.g., smartphones, cell phones, personal digital assistants, messaging devices, pocket PCs, etc.), connectivity and charging devices (e.g., hubs, docking stations, adapters, chargers, etc.), audio/video/data recording and/or playback devices (e.g., cameras, voice recorders, hand-held scanners, monitors, etc.), body-wearable devices, and other similar electronic devices. For example, embodiments described herein can be used to predict an activity class, along with a confidence score (e.g., reliability) of the prediction, such that the activity recognition system can fail without posing a threat to safety-critical solutions. Human activity recognition can be used in various applications, such as smart home applications (e.g., heating, ventilation, air conditioning, lighting), healthcare monitoring applications, human-machine interface system applications, etc.

The following description sets forth numerous specific details, such as examples of specific systems, components, methods, and so forth, in order to provide a good understanding of various embodiments of the techniques described herein for implementing activity recognition with integrated uncertainty. It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the spirit and scope of the present invention.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment of the invention. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

FIG. 1 is a block diagram of an example computer system (“system”) 100, in accordance with some embodiments. The system 100 can be integrated within an embedded system, such as a distributed computing and control system of a vehicle, airplane, or other more extensive operation device. The system 100 can include a processing device 110 for managing data drift in neural networks using incremental learning and explainability, in accordance with some embodiments of the present disclosure. The system 100 can also include a host device 150.

The processing device 110 can include an analog and/or digital general-purpose input/output (“GPIO”) ports 107. The GPIO ports 107 can be coupled to a Programmable Interconnect and Logic (“PIL”), which acts as an interconnect between GPIO ports 107 and a digital block array of the processing device 110 (not shown). The digital block array can be configurable to implement a variety of digital logic circuits (e.g., DAC, digital filters, or digital control systems) using, in one embodiment, configurable user modules (“UMs”). The digital block array may be coupled to a system bus. Processing device 110 can also include memory 104, such as random-access memory (“RAM”) and program flash. RAM can be static RAM (“SRAM”), and program flash can be a non-volatile storage, which may be used to store firmware (e.g., control algorithms executable by processing core 102 (e.g., a central processing unit (CPU)) to implement operations described herein). Processing device 110 can also include a memory controller unit (“MCU”) 103 coupled to the memory 104 and the processing core 102. In some embodiments, the MCU 103 can implement the building of generalized machine learning models from machine learning model explanations, as will be described in further detail herein. The processing core 102 is a processing element configured to execute instructions or perform operations. The processing device 110 can include other processing elements as would be appreciated by one or ordinary skill in the art having the benefit of this disclosure. It should also be noted that the memory 104 can be internal to the processing device or external. In the case of the memory 104 being internal, the memory 104 can be coupled to a processing element, such as the processing core 102. In the case of the memory 104 being external to the processing device 110, the processing device 110 can be coupled to the other device in which the memory 104 resides, as would be appreciated by one of ordinary skill in the art having the benefit of this disclosure. The processing device 110 can also include an analog block array (not shown). The analog block array can be coupled to a system bus (not shown). The analog block array can also be configurable to implement a variety of analog circuits (e.g., ADCs or analog filters) using, in one embodiment, configurable UMs. The analog block array can also be coupled to the GPIO 107.

As illustrated, a generalized machine learning model (MLM) component 120 can be integrated into the processing device 110. The generalized MLM component 120 can include an analog I/O coupled to an external component. The generalized MLM component 120 can be configurable to implement the building of generalized machine learning models from machine learning model explanations, as will be described in further detail herein. In some embodiments, the generalized MLM component 120 can be implemented using the MCU 103 by the host device 150.

The processing device 110 can also include internal oscillator/clocks 106 and communication component 108. The internal oscillator/clocks 106 can provide clock signals to one or more components of the processing device 110. The communication component 108 can be used to communicate with an external component, such as the host device 150, via a host interface over a network. In some embodiments, the processing device 110 can be coupled to an embedded controller to communicate with the external components, such as the host device 150. In some embodiments, the processing device 110 is configurable to communicate with the host device 150 to send and/or receive data.

The host device 150 can be any desktop computer, laptop computer, tablet, phone, smart TV, sensor, appliance, system controller (e.g., an air conditioning, heating, water heating controller), component of a security system, medical testing, monitoring equipment, or any other type of a device. The host device 150 can be coupled (e.g., via a wired and/or wireless connection) to a respective wireless device of the system 100. In some embodiments, the wireless device can be implemented as an integrated circuit (IC) device (e.g., disposed on a single semiconductor die).

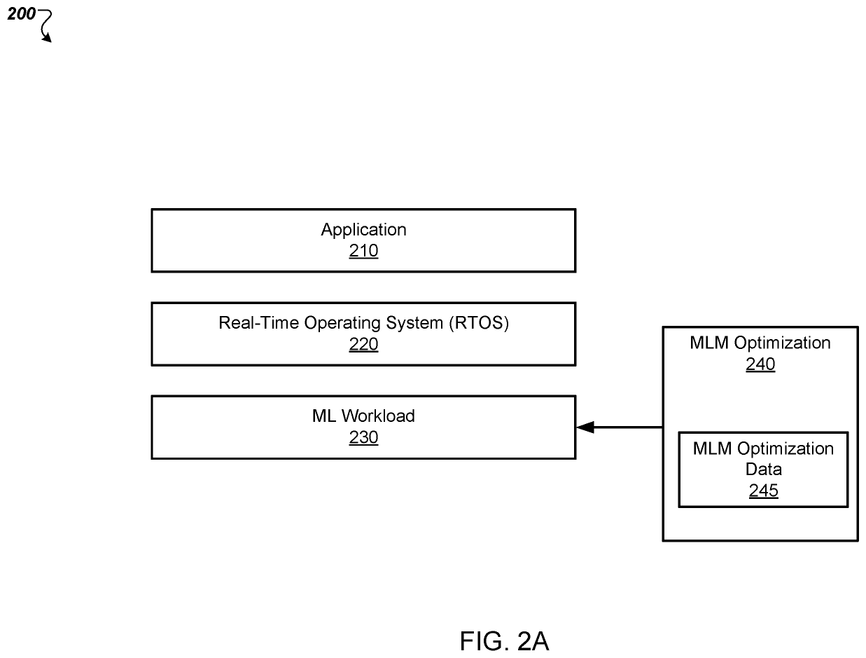

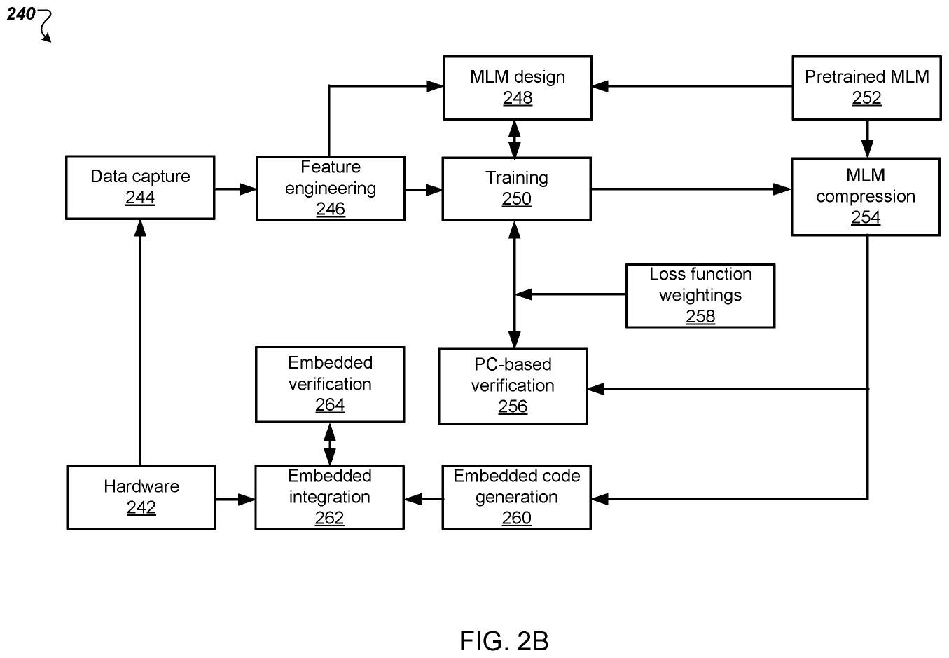

In some embodiments, the system 100 can include other elements not shown in FIG. 1, such as user interface devices (e.g., a mouse, a keyboard, etc.). Numerous other implementations and multiple variations of these implementations with regard to the generalized MLM component 120 will now be described below with reference to FIGS. 2A-7.

FIG. 2A is a block diagram of an example system 200 including an embedded stack for machine learning applications, according to some embodiments. As shown, the system 200 includes an application 210 corresponding to a host device (e.g., client device), an operating system (OS) 220, and a machine learning (ML) workload 230. Although not shown in FIG. 2, the system 200 can include other components. For example, the system 200 can include a set of wireless stacks, a set of sensors, a set of drivers, etc.

In some embodiments, the application 210 is a real-time application, and the OS 220 is a real-time operating system (RTOS). The application 210 and the OS 220 can be included within a real-time computing system. A real-time computing system is a computing system that is subject to at least one real-time constraint (“deadline”). Thus, missing a deadline is a system failure, and missed deadlines degrade the quality of service of the real-time computing system. A real-time application refers to an application that can guarantee a response in accordance with the at least one deadline. An RTOS refers to an OS that can process data and events in accordance with the at least one deadline. The ML workload 230 can include at least one ML-based application.

The ML workload 230 can be communicably coupled to a machine learning model (MLM) optimization component 240. The MLM optimization component 240 can implement an embedded ML development flow to generate MLM optimization data 245, and the ML workload 230 can receive the MLM optimization data 245 to optimize one or more MLMs. Further details regarding the MLM optimization component 240 will now be described below with reference to FIG. 2B.

FIG. 2B is a block diagram of an example MLM optimization component 240, according to some embodiments. As shown, the MLM optimization component 240 includes hardware 242, a data capture component 244, a feature engineering component 246, MLM design component 248, training component 250, a pretrained MLM 252, model compression component 254, MLM evaluation verification component 256, loss function weightings component 258, embedded code generation component 260, embedded integration component 262, and embedded verification component 264.

The data capture component 244 can receive data from the hardware 242. The feature engineering component 246 can engineer a set of features from the data received from the hardware 242.

The MLM design component 248 can design an MLM based on the pretrained MLM 252 and the set of features engineered by the feature engineering component 246. The training component 250 can obtain a trained MLM using the MLM designed by the MLM design component 248.

The MLM compression component 254 can use the pretrained MLM 252 and the trained MLM output by the training component 250 to obtain a compressed MLM.

While smaller MLMs are easier to deploy and have faster inference times, compression techniques often come at the cost of reduced accuracy. The MLM evaluation verification component 256 can verify the performance of the compressed MLM. Verifying the performance of the compressed MLM can include determining that the compressed MLM can make accurate predictions. For example, verifying the performance of a compressed MLM can be used to ensure that the smaller size of the compressed MLM, relative to the original MLM, has not resulted in any significant loss of performance. This verification can help in making informed decisions about whether to continue using the new method or to explore alternative methods for further MLM performance enhancement. Accordingly, by verifying the performance of the compressed MLM, one can assess if the trade-off between model size and accuracy is acceptable and make informed decisions about using the compressed MLM in practical applications

The loss function weightings component 258 can optimize a loss function to enhance MLM performance. The goal of optimizing the loss function is to find the values of model parameters that minimize the difference between the predicted output and actual output. This minimization can be performed using various optimization methods. One example of an optimization method is gradient descent, which calculates the gradient of the loss with respect to the model parameters and updates the parameters in the direction of steepest decrease. By minimizing the loss, the weights of the model are improved, leading to better predictions.

There are various examples of weighting methods of weighting a loss function in a MLM that can be used. The choice of weighting method can depend on the specific problem and the desired outcome. One example of a weighting method is equal weight, in which all data points are assigned an equal weight (i.e., each data point contributes equally to the loss calculation). Another example of a weighting method is class imbalance weighting, which can be used to give more importance to a minority class in cases where the number of examples in each class is imbalanced. Yet another example of a weighting method is instance weighting, which can be used to assign a weight to an instance in cases where it may be desirable to adjust the contribution of the instance to the loss calculation (e.g., when some instances are more important than others). Yet another example of a weighting method is dynamic weighting, in which the weight assigned to each instance can be dynamically adjusted during training based on one or more metrics (e.g., prediction error).

The embedded code generation component 260 can use the compressed MLM to generate embedded code. The embedded integration component 262 can generate an embedded integration from the embedded code, which can be provided to the ML workload 130 described above with reference to FIG. 1. Moreover, the embedded verification component 264 can obtain an embedded verification result from the embedded integration.

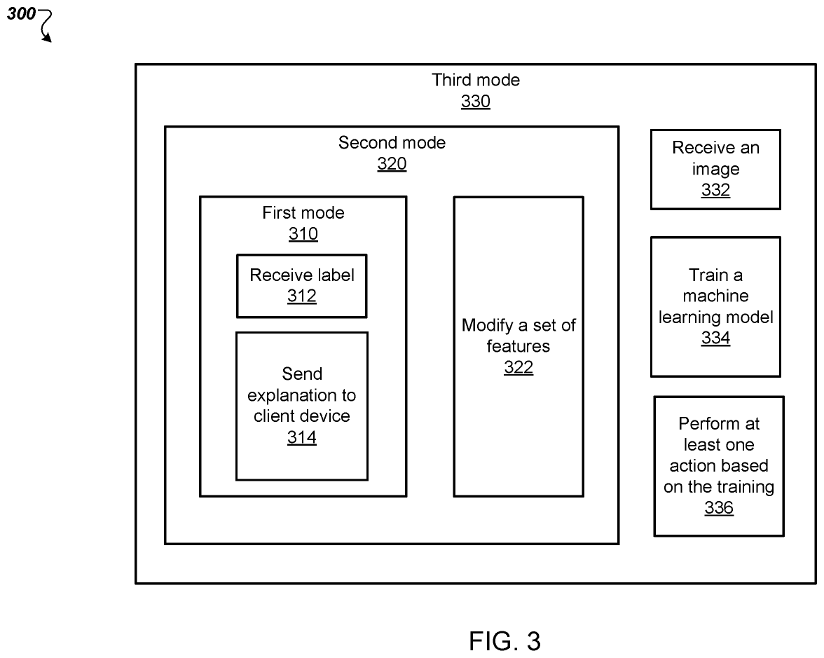

FIG. 3 is a block diagram of example user interface modes 300 for building generalized machine learning models from machine learning model explanations, according to some embodiments. As shown, the user interface modes 300 can include a first mode 310, a second mode 320, and a third mode. In some embodiments, the first mode 310 is a basic mode, the second mode 320 is an advanced mode, and the third mode is a query mode 330.

For example, during the first mode 310, a processing device can receive a label at block 312, and perform at least one action based on the label at block 314.

During the second mode 320, a processing device can maintain data proportion at block 322, and weigh features at block 324.

During the third mode 330, a processing device can receive an image at block 332, and perform at least one action based on image analysis at block 334.

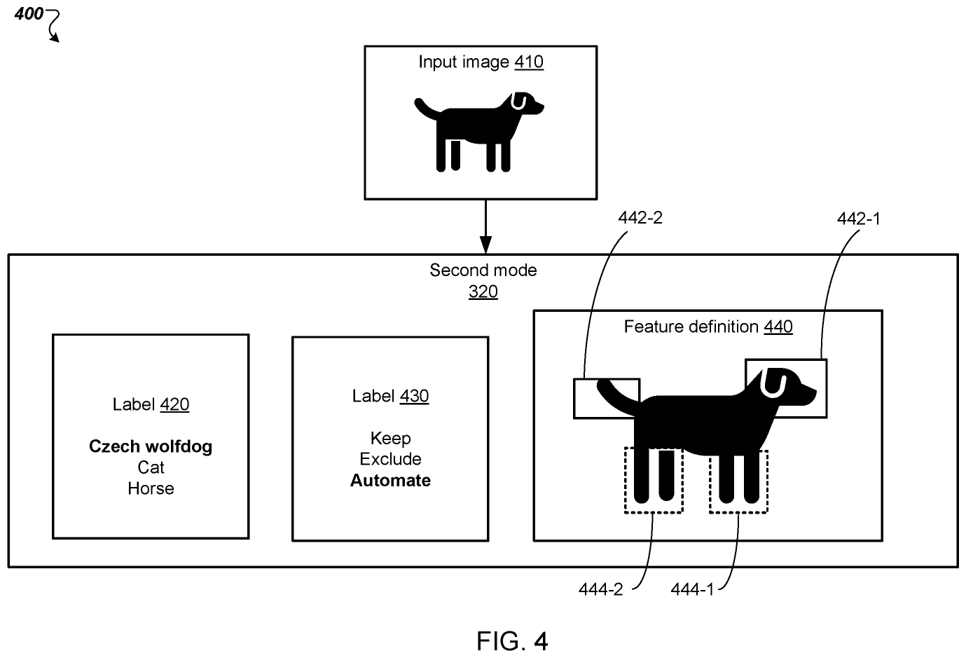

FIG. 4 is a diagram 400 of an example implementation of a user interface mode for building generalized machine learning models from machine learning model explanations, according to some embodiments. More specifically, the user interface mode is the second mode 320 (e.g., the advanced mode), as described above with reference to FIG. 3.

As shown, an input image 410 is received by a computing device operating in the second mode 320. In this illustrative example, the input image 410 is a dog and, more particularly, a golden retriever. While in the second mode 320,

A feature definition 440 can include a first set of features including features 442-1 and 442-2, and a second set of features including features 444-1 and 444-2. More specifically, the first set of features includes features that are identified as being the most important for predicting that the dog of the input image 410 is a golden retriever. The second set of features includes features that are less important for predicting that the dog of the input image 410 is a golden retriever. The importance can be defined by generating a set of explainability data, which can be used to identify important features. The set of explainability data can be used to automatically generate a set of weights for incorrect predictions that will force the MLM to recognize the dog as a golden retriever.

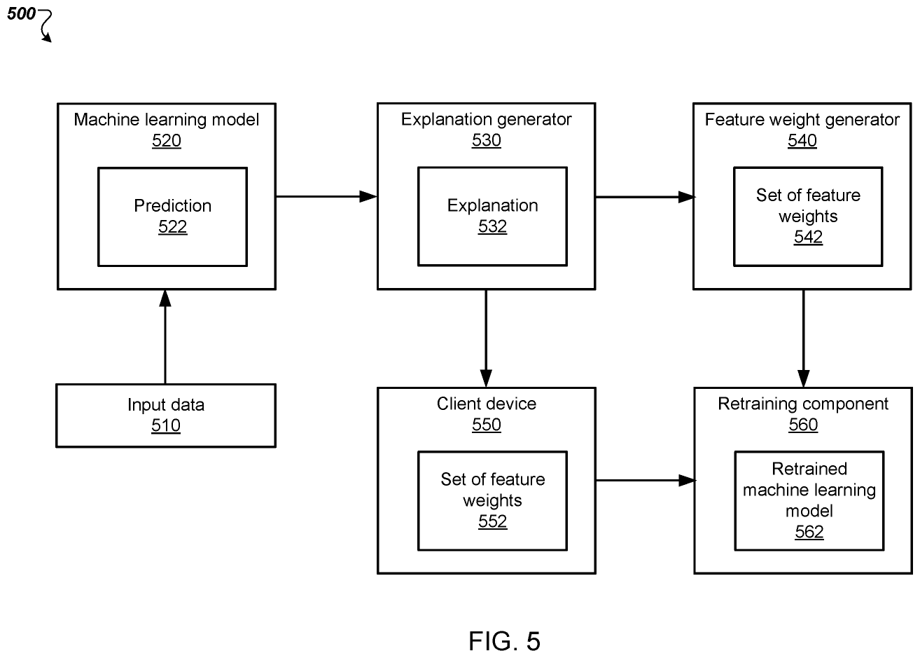

FIG. 5 is a block diagram of an example system 500 for building generalized machine learning models from machine learning model explanations, according to some embodiments. As shown, input data 510 is received as input into machine learning model 520 to make a prediction 522. In some embodiments, the input data 510 includes at least one of: a raw data corresponding to an object, a visual object representation of the object, or a set of features corresponding to the object. For example, the raw data can include at least one of: a raw image, raw audio, etc. In some embodiments, obtaining the input data includes processing the raw data to generate the visual object representation. For example, if the raw data includes raw audio, then the visual object representation can include a spectrogram.

The prediction 522 is received by an explanation generator 530 to generate at least one explanation 532. In some embodiments, the at least one explanation 532 is a visual explanation. In some embodiments, the at least one explanation 532 is a LIME. In some embodiments, the at least one explanation 532 is a LIME-based visual explanation.

The at least one explanation 532 is received by a feature weight generator 540 to generate a set of feature weights 542. More specifically, each feature weight of the set of feature weights 542 can be automatically determined for a respective feature of the set of features of the object. For example, the feature weight generator 540 can be used to generate the set of feature weights 542 during the advanced mode and/or the query mode described above.

Additionally or alternatively, the at least one explanation is received by a client device 550 to generate a set of feature weights 552. More specifically, each feature weight of the set of feature weights 552 can be determined by a user for a respective feature of the set of features of the object. For example, the feature weight generator 550 can be used to generate the set of feature weights 552 during the basic mode, as described above.

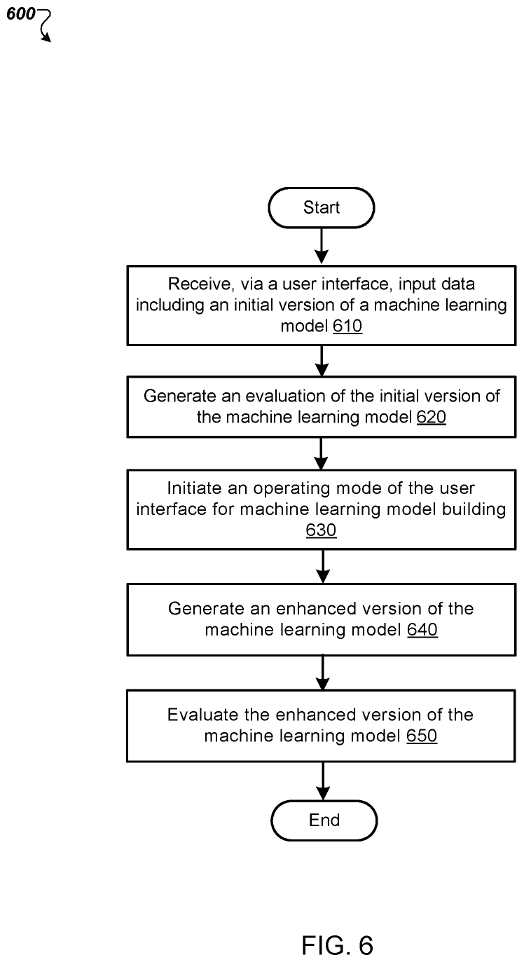

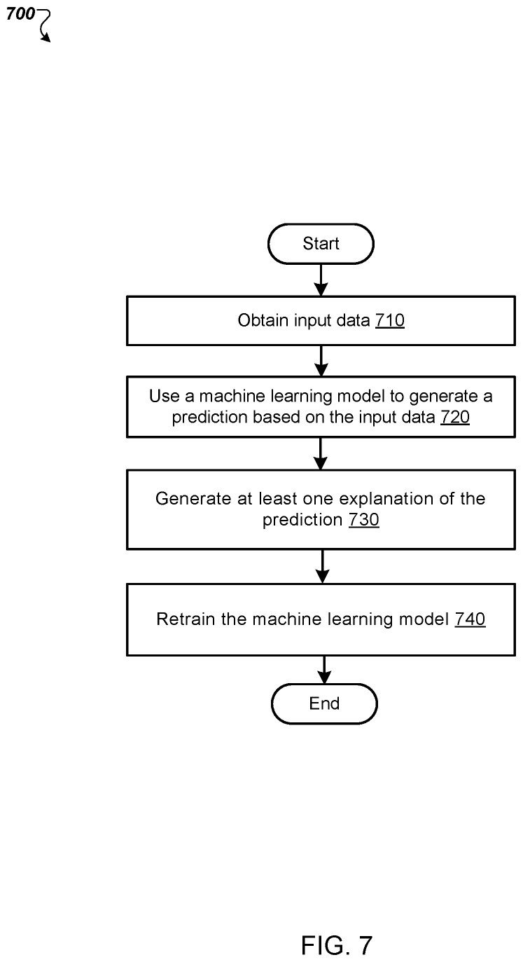

The set of feature weights 542 and/or the set of feature weights 552 can be received by a retraining component 560 to retrain the machine learning model and obtain a retrained machine learning model 562. More specifically, the machine learning model is trained using the set of feature weights 542 and/or the set of feature weights 552. Further details regarding building generalized machine learning models from machine learning model explanations will now be described below with reference to FIGS. 6-7.

FIG. 6 is a flow diagram of a method 600 of building generalized machine learning models from machine learning model explanations, according to some embodiments. Method 600 may be performed by processing logic that comprises hardware (e.g., circuitry, dedicated logic, programmable logic, microcode, etc.), software, firmware, or a combination thereof. In some embodiments, method 600 is performed by the generalized MLM component 120 of FIG. 1 and/or the system 500 of FIG. 5.

At block 610, processing logic receives, from a client device via a user interface, input data including an initial version of a machine learning model. For example, the user interface can be a GUI. In some embodiments, the input data further includes a set of user data. The machine learning model can make predictions with respect to any suitable type of data. For example, the machine learning mode can make predictions with respect to image data, audio data, etc.

At block 620, processing logic generates an evaluation of the initial version of the machine learning model. The evaluation of the initial version of the machine learning model can correspond to a baseline evaluation of the machine learning model. For example, the evaluation can indicate a prediction made using the initial version of the machine learning model and/or an accuracy of the prediction made using the initial version of the machine learning model.

At block 630, processing logic initiates an operating mode of the user interface for machine learning model building. For example, processing logic can receive, via the user interface, a selection of the operating mode. In some embodiments, the operating mode is a basic mode. In some embodiments, the operating mode is an advanced mode, In some embodiments, the operating mode is a query mode. Further details regarding the operating modes are described above with reference to FIGS. 1-5.

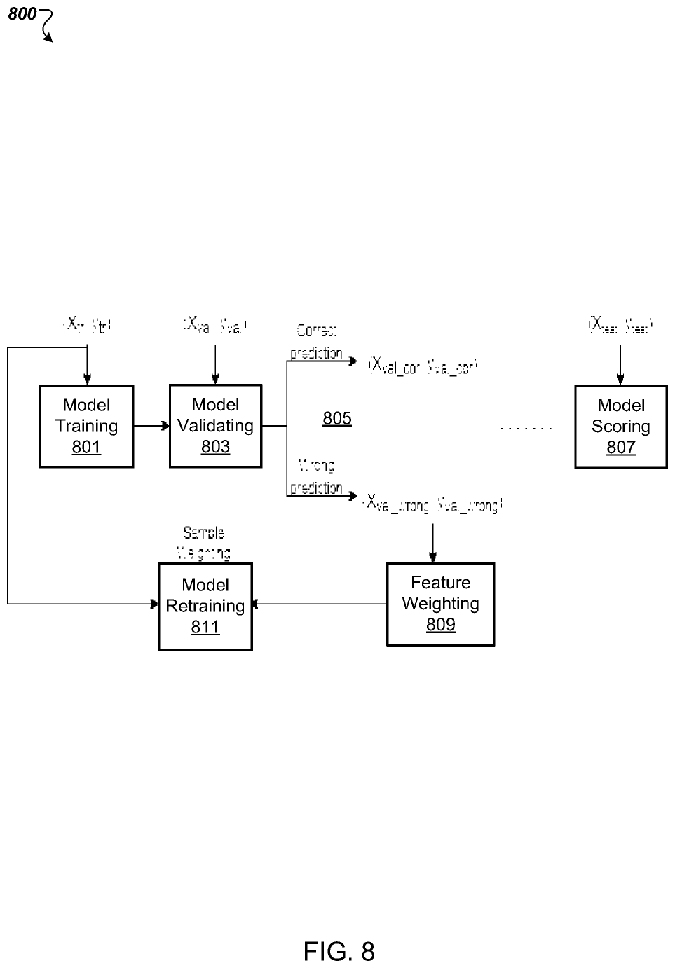

At block 640, processing logic generates an enhanced version of the machine learning model in accordance with the operating mode. In some embodiments, the enhanced version of the machine learning model is generated based on at least one explanation of the machine learning model. In some embodiments, the at least one explanation includes a visual explanation. In some embodiments, the at least one explanation includes a LIME explanation. In some embodiments, the at least one explanation includes a LIME-based visual explanation. For example, generating the enhanced version of the machine learning model can include retraining the machine learning model using retraining data derived based at least in part on at least one explanation. In some embodiments, the retraining data includes a set of feature weights. Each feature weight of the set of feature weights corresponds to a respective feature of the set of features, and can be determined based on an analysis of the at least one explanation. More specifically, the retraining includes only incorrectly predicted samples. The training can use a customized loss to include a weighting factor to the incorrectly predicted samples being added to the training set. Further details regarding generating the enhanced machine learning are described above with reference to FIGS. 1-5 and will now be described in further detail below with reference to FIGS. 7-8.

At block 650, processing logic evaluates the enhanced version of the machine learning model. Evaluating the enhanced version of the machine learning model can include generating an evaluation of the enhanced version of the machine learning model, and comparing the evaluation of the enhanced version of the machine learning model with the baseline evaluation (i.e., the evaluation of the initial version of the machine learning model). For example, the evaluation of the enhanced version of the machine learning model can indicate a prediction made using the enhanced version of the machine learning model and/or an accuracy of the prediction made using the enhanced version of the machine learning model. The comparison can be performed to determine whether the enhanced version of the machine learning model is at least as accurate as the initial version of the machine learning model.

FIG. 7 is a flow diagram of a method 700 of building generalized machine learning models from machine learning model explanations, according to some embodiments. Method 700 may be performed by processing logic that comprises hardware (e.g., circuitry, dedicated logic, programmable logic, microcode, etc.), software, firmware, or a combination thereof. In some embodiments, method 700 is performed by the generalized MLM component 120 of FIG. 1 and/or the system 500 of FIG. 5.

At block 710, processing logic obtains input data. For example, the input data can be received via a user interface (e.g., GUI). In some embodiments, the input data includes a machine learning model. In some embodiments, the input data includes a set of user data. In some embodiments, the input data includes at least one of: a raw data corresponding to an object, a visual object representation of the object, or a set of features corresponding to the object. For example, the raw data can include at least one of: a raw image, raw audio, etc. In some embodiments, obtaining the input data includes processing the raw data to generate the visual object representation. For example, if the raw data includes raw audio, then the visual object representation can include a spectrogram.

At block 720, processing logic uses a machine learning model to generate a prediction based on the input data. For example, processing logic can generate the prediction based on the set of features.

At block 730, processing logic generates at least one explanation of the prediction. In some embodiments, the at least one explanation is a visual explanation. In some embodiments, the at least one explanation is a LIME. In some embodiments, the at least one explanation is a LIME-based visual explanation.

At block 740, processing logic retrains the machine learning model. More specifically, the machine learning model can be retrained using input data derived based at least in part on the at least one explanation. In some embodiments, the input data includes a set of feature weights. Each feature weight of the set of feature weights corresponds to a respective feature of the set of features, and can be determined based on an analysis of the at least one explanation. More specifically, the retraining includes only incorrectly predicted samples. The training can use a customized loss to include a weighting factor to the incorrectly predicted samples being added to the training set.

In some embodiments, the set of feature weights is generated by a client device. For example, the at least one explanation can be sent to the client device, and a user of the client device can generate the set of feature weights based on the at least one explanation. In some embodiments, the set of feature weights is automatically generated based on the at least one explanation. More specifically, the set of feature weights can be generated for incorrect predictions using the at least one explanation.

In some embodiments, retraining the machine learning model includes retraining the machine learning model with incremental learning. Incremental learning feeds unseen test cases in sequential sessions into a trained machine learning model and allows for focus on rectifying incorrect predictions in a sequential fashion. Incremental learning can address data distribution draft (“data drift”). Data drift, which can decrease machine learning model prediction accuracy, can occur due to various reasons, such as changes in input data after a machine learning model has already been deployed in an embedded system.

Using a human-machine interface (e.g., voice assistant) as an example, certain systems use a spoken keyword spotting system (“KWS”) to activate the voice assistant upon hearing a predefined keyword. More specifically, the voice assistant can enter a voice command receiving mode upon hearing the predefined keyword. Using a KWS system can reduce computational expenses when voice assistance is not needed. Thus, a KWS system can be defined as the task of identifying keywords in audio streams, including speech, and has become a fast-growing technology due to the paradigm shift introduced by deep learning (e.g., neural networks). Some KWS systems can utilize continuous KWS to identify the predefined keyword in a continuous speech. One advantage of this approach is the flexibility to deal with changing and/or non-predefined keywords. However, such continuous KWS implementations can have high computational complexity.

Some systems can utilize an internal learning technique in which a learning agent, at timestep t, is trained to recognize tasks 1 through t while the datasets for these tasks D₁ through Dₜ may or may not be available. Knowledge transfer (KT) measures how incremental learning up to task t influences the agent's knowledge about the task. In terms of performance, a positive KT suggests that the agent should deliver better accuracy on the task if it were allowed to incrementally learn the task t through tasks 1 through t−1 while achieving a low validation error on all of the datasets D₁ through Dₜ. On the other hand, semantic transfer (ST) measures the influence that learning a task t has on the performance of a previous task. A positive ST means that learning a new task t would increase model performance with respect to the previously learned tasks 1 through t−1. Accordingly, a trade-off can exist between KT and ST. In some embodiments, a task is a KWS task.

Some incremental learning approaches used to find the trade-off between KT and ST include architecture-based approaches and memory-based approaches. Architecture-based approaches (e.g., progressive nets) evolve network size after every task while assimilating the new knowledge with past knowledge. Memory-based approaches (e.g., gradient episodic memory) can store a memory of each of the previous tasks while learning the new task. However, architecture-based and memory-based approaches can be resource-intensive (e.g., processor and/or memory).

In some embodiments, retraining the machine learning model with incremental learning includes implementing regularization-based incremental learning. Regularization-based incremental learning can assume a fixed network size and learn new tasks while trying to avoid changes to parameters that are sensitive to previous tasks. Regularization-based incremental learning can be a regularization-based elastic weight consolidation (EWC) incremental learning. A model parameter θ*_{1:i-1} configuration for each of tasks 1 through i−1 can be achieved at the end of dataset Dᵢ, which is expected to solve all datasets D_{1:i}. The posterior maximization over the new task is equivalent to the likelihood maximization for the new dataset and the posterior maximization on the previous dataset. For example:

$${max}_{θ} log p ( θ \vert {D}_{1 : i} ) = {max}_{θ} [ log p ( {D}_{1 : i} \vert θ ) + log p ( θ ) ] = {max}_{θ} [ log p ( {D}_{i} \vert θ ) + log p ( θ \vert {D}_{1 : i - 1} ) \qquad ( 1 )$$

Equation (1) can be minimized by adding a regularization loss, which can prevent θ*_{1:i} from veering too far away from θ*_{1:i-1}. Since this regularization loss should preserve closeness to the previous solution, the Kullback-Leibler (KL)-divergence between p(θ|D_{1:1}) and p(θ|D_{1:i-1}) can be used as the regularization loss. For example:

$$K L ( ( p ( θ \vert {D}_{1 : i} ) ‖ p ( θ \vert {D}_{1 : i - 1} ) ) \approx \frac{1}{2} {\sum }_{j} {{F}_{jj} ( {θ}_{j} - {θ}_{1 : i - 1 , j}^{*} )}^{2} \qquad ( 2 )$$

where Fⱼⱼ refers to the diagonal of the empirical Fisher matrix.

The EWC approach described above can act as a regularizer to prevent catastrophic forgetting (e.g., where adding new data to the training regime may negatively impact the learned distribution and can force the model to perform poorly on previous tasks or examples) by forcing the machine learning model to retain existing data while simultaneously incorporating new data. However, the EWC approach can limit the machine learning model from learning information from the new data. Although the EWC approach can preserve KT, equation (1) introduces some challenges. One challenge is data-dependent optimization. For example, as optimization is performed using maximum likelihood estimation, the ST can depend highly on the examples used during training and their similarity coefficients. That is, dataset components with less similarity can suffer more semantic loss during ST, and vice versa. Due to the end-to-end nature of machine learning models (e.g., neural networks), machine learning models can often be considered as “black boxes,” where the reasons for certain outputs or predictions made by neural network models may not be known.

To address this, the retraining of the machine learning model can include integrating the set of feature weights, generated based on the at least one explanation, into the EWC approach described above to improve the machine learning model's prediction accuracy. In some embodiments, a set of explanation metrics can be used as a weighting factor during the retraining to improve ST learning between tasks. Incorrect predictions can be taken and included in a new training set. This can help the machine learning model to imitate memory-based approaches. In some embodiments, the set of explanation metrics can include a set of LIME scores. For example, a weighted loss can be used during model training, in which the weights from the samples are derived from the difference between LIME-based visual explanations of the true and predicted classes. As a result, the model can focus more on rectifying incorrect predictions with higher weights, improving the ability to learn new data. In some embodiments, the accuracy of a machine learning model task can be enhanced by determining the importance of segments within input data (e.g., an input spectrogram) to isolate activity regions. To this end, the LIME-based visual explanations described herein can be used to generate sample weights for weighted loss, which can be used in an incremental learning method to improve the accuracy of machine learning models. Further details regarding blocks 610-640 are described above with reference to FIGS. 1-5 and will now be described below with reference to FIGS. 7-8.

FIG. 8 is a flow diagram of an example method 800 for retraining a machine learning model using incremental learning and explainability, in accordance with some embodiments of the present disclosure. Method 800 may be performed by processing logic that comprises hardware (e.g., circuitry, dedicated logic, programmable logic, microcode), software (e.g., instructions run on a processing device to perform hardware simulation), or a combination thereof. In some embodiments, method 800 is performed by generalized MLM component 120 of FIG. 1 and/or system 500 of FIG. 5.

At block 801, processing logic trains a machine learning model with one or more data samples (e.g., one or more data samples xₜᵣ, yₜᵣ as illustrated in FIG. 8) to obtain a trained machine learning model. In some embodiments, training the machine learning model can include feeding input data into the machine learning model, where the input data includes data representing the one or more data samples. In some embodiments, the machine learning model can be a deep neural network model (i.e., DNN model) and/or a very deep convolutional network model (i.e., VGG model).

At block 803, processing logic validates the trained machine learning model. In some embodiments, the trained machine learning model is validated using one or more new data samples (e.g., one or more data samples xᵥₐₗ, yᵥₐₗ, as illustrated in FIG. 8). Any suitable validation method can be used to validate the machine learning model. For example, the validation method can include one or more of: random subsampling, bootstrapping, nested cross-validation, K-fold cross-validation, etc.

At block 805, processing logic identifies a set of predicted data samples. For example, the set of predicted data samples can be identified in response to validating the trained machine learning model. The set of predicted data samples can include one or more correctly predicted data samples (e.g., x_{val_cor}, y_{val_cor} as illustrated in FIG. 8) and/or one or more incorrectly predicted data samples (e.g., x_{val_wrong}, y_{val_wrong} as illustrated in FIG. 8). In some embodiments, the set of predicted data samples can be included in output data generated by the trained machine learning model. The output data can include data representing the one or more correctly predicted and/or incorrectly predicted data samples.

At block 807, processing logic scores the set of predicted data samples. For example, scoring the set of predicted data samples can include comparing the performance of the trained machine learning model using the one or more data samples with the performance of previous trainings of the machine learning model. The performance of the trained machine learning model can be quantified based on the number of correctly predicted data samples and the number of incorrectly predicted data samples of the set of predicted samples. More specifically, the greater number of correctly predicted data samples, the higher performance of the trained machine learning model.

At block 809, processing logic generates a set of feature weights. More specifically, each feature weight of the set of feature weights corresponds to a respective value assigned to a respective incorrectly predicted data samples of the set of predicted data samples. Each value can refer to a feature importance score for the incorrectly predicted data sample. In some embodiments, generating the set of feature weights includes using an explainability tool that can be used as a feedback loop and to provide at least one explanation (e.g., LIME-based visual explanation). For example, the at least one explanation can include a heatmap overlayed on top of an image according to weight and/or gradient activation.

In some embodiments, generating the set of feature weights can include obtaining a visual object representation (e.g., spectrogram), segmenting the visual object representation into one or more segments, and generating a variation of the visual object representation. In some embodiments, the visual object representation is a LIME-based visual object representation.

In some embodiments, the processing logic can segment the spectrogram into the one or more segments using a clustering algorithm. The clustering algorithm can refer to any algorithm that performs cluster analysis in machine learning, such as to divide and/or group data into one or more groups where the data in one group are more similar to other data in the same group and dissimilar to data in another group. For example, the clustering algorithm can be a density-based clustering algorithm, a distribution-based clustering algorithm, a centroid-based clustering algorithm, a hierarchical-based clustering algorithm, a K-means clustering algorithm, a Gaussian mixture model clustering algorithm, a Balance Iterative Reducing and Clustering using Hierarchies (BIRCH) clustering algorithm, an affinity propagation clustering algorithm, and/or a mean-shift clustering algorithm, etc.

Certain clusters of the variation of the visual object representation can be designated as the most influential (e.g., important) clusters. In some embodiments, the processing logic generates the variation of the visual object representation by performing a perturbation process. The perturbation process can be performed using any suitable perturbation technique.

In some embodiments, generating the set of feature weights can further include providing the variation of the spectrogram as input into the trained machine learning model. The trained machine learning model can predict one or more classes (e.g., classifications) of the variation of the visual object representation.

In some embodiments, generating the set of feature weights can further include obtaining output data indicative of the one or more classes predicted by the trained machine learning model for the variation of the visual object representation. For example, the output signal can be data that includes the one or more classification predictions for the variation of the visual object representation.

In some embodiments, generating the set of feature weights can further include determining a distance between the variation of the visual object representation and the original visual object representation. In some embodiments, the distance is a cosine-based distance. In some embodiments, the distance is a Euclidean-based distance. In some embodiments, the distance is a Manhattan-based distance.

In some embodiments, generating the set of feature weights can include obtaining the feature weight for each incorrectly predicted data sample by fitting a linear regression classifier model on the variation of the spectrogram and the one or more classes. The processing logic can use the distance between the variation of the visual object representation and the original visual object representation as a weight in the linear regression classifier model. In some embodiments, each coefficient of the linear regression classifier model can be the weighted value for each data sample. An example algorithm for generating the feature weight for each incorrectly predicted data sample is provided as follows:

$$\begin{matrix}Require : {X}_{i n} , {θ}^{t} \\ C = Cluster ( {X}_{i n} ) \\ var ← [ null ] , σ = 0.2 \\ for i in [ 1 , 2 , … n ] do \\ V = Peturbation ( C ) \\ var . append ( V ) \\ end for \\ pred = Predict ( {θ}^{t} , var ) \\ dist = Cosine Distance ( {X}_{in} , var ) \\ w = \sqrt{{e}^{( \frac{- {dist}^{2}}{{σ}^{2}} )}} \\ reg = Linear Regression ( var , pred , wt ) \\ score = coeff ( reg )\end{matrix}$$

where σ refers to a kernel width and can be set to any value, such as 0.25.

An example equation for generating the set of feature weights is provided as follows:

Σᵢ₌₀ⁿ(Lₚⁱ−Lₜⁱ)², n=#segments/features (3)

where (Lₚⁱ−Lₜⁱ)² can refer to the Euclidean distance between the variation of the spectrogram (Lₜⁱ) and the prediction classification of the visual object representation (Lₚⁱ), n refers to a number (e.g., a total number, count, value, etc.) of the one or more segments of the visual object representation.

At block 811, processing logic retrains the machine learning model using the set of feature weights. In some embodiments, retraining the machine learning model can include modifying each incorrectly predicted data sample of the set of predicted data samples based on the set of feature weights to compute a modified set of data samples. An example equation for retraining the machine learning model using the modified set of data samples is provided as follows:

−(Σᵢ₌₁^{output size}yᵢ·log ŷᵢ)·feature weight (4)

Another example equation for retraining the machine learning model using the modified set of data samples is provided as follows:

−(Σᵢ₌₁^{output size}yᵢ·log ŷᵢ)+feature weight (5)

In some embodiments, the processing logic can retrain the machine learning model by further applying a regularization parameter. For example, the regularization parameter can be an elastic weight consolidation (EWC) parameter, where score importance can be based on a fisher information matrix (FIM). FIM refers to information that an observable random variable X carries about an unknown parameter θ which can model the distribution of X. In some embodiments, the EWC parameter can be used to address catastrophic forgetting and allow the machine learning model to retain previously learned information in addition to adding new information (e.g., data samples), as discussed in more detail herein. In some embodiments, the regularization parameter can be applied to the weighted value generated using an equation such as the following:

$$Loss = L o s {s}_{p} + {\sum }_{i} \frac{λ}{2} {{F}_{i} ( {θ}_{i} - {θ}_{prev} )}^{2} \qquad ( 6 )$$

where Lossₚ refers to a feature weight, F(θᵢ) refers to the FIM from parameters of the one or more data samples (e.g., the one or more data samples currently used to train the machine learning model), F(θₚᵣₑᵥ) refers to the FIM from parameters of one or more data samples used in previous trainings of the machine learning model, i refers to a size (e.g., a count, a total number, a total value, etc.) of the one or more data samples (e.g., the one or more data samples currently used to train the machine learning model), and λ refers to a value (e.g., 1) that controls the amount of EWC regularization applied to Lossₚ.

In some embodiments, processing logic can validate the retrained machine learning model. Validating the modified machine learning model can be performed using one or more new data samples. Any suitable validation method can be used to validate the retrained machine learning model. For example, the validation method can include one or more of: random subsampling, bootstrapping, nested cross-validation, K-fold cross-validation, etc.

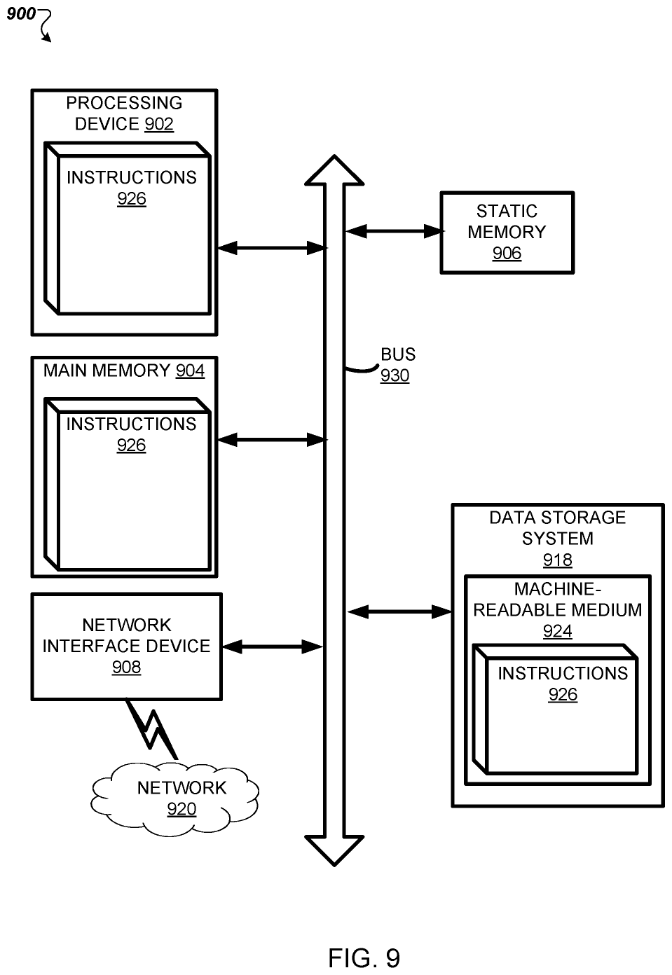

FIG. 9 illustrates an example machine of a computer system 900 within which a set of instructions, for causing the machine to perform any one or more of the methodologies discussed herein, can be executed. In some embodiments, computer system 900 can correspond to a computing device that can be used to perform the operations of generalized MLM component 120 of FIG. 1 and/or system 500 of FIG. 5. In alternative embodiments, the machine can be connected (e.g., networked) to other machines in a LAN, an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

Example computer system 900 includes processing device 902, main memory 904 (e.g., read-only memory (ROM), flash memory, dynamic random access memory (DRAM) such as synchronous DRAM (SDRAM), static memory 906 (e.g., flash memory, static random access memory (SRAM), etc.), and data storage system 918, which communicate with each other via bus 930.

Processing device 902 represents one or more general-purpose processing devices such as a microprocessor, a central processing unit, or the like. More particularly, processing device 902 can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 can also be one or more special-purpose processing devices such as an application-specific integrated circuit (ASIC), a field programmable gate array (FPGA), a digital signal processor (DSP), network processor, or the like. Processing device 902 is configured to execute instructions 926 for performing the operations and steps discussed herein. Computer system 900 can further include network interface device 908 to communicate over network 920.

Data storage system 918 can include machine-readable storage medium 924 (also known as a computer-readable medium) on which is stored one or more sets of instructions 926 or software embodying any one or more of the methodologies or functions described herein. Instructions 926 can also reside, completely or at least partially, within main memory 904 and/or within processing device 902 during execution thereof by computer system 900, main memory 904 and the processing device 902 also constituting machine-readable storage media. Machine-readable storage medium 924, data storage system 918, and/or main memory 904 can correspond to the generalized MLM component 120 of FIG. 1 and/or the system 500 of FIG. 5.

In one embodiment, instructions 926 include instructions to implement functionality corresponding to generalized MLM component 120 of FIG. 1 and/or system 500 of FIG. 5. While machine-readable storage medium 924 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In the above description, some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining”, “allocating,” “dynamically allocating,” “redistributing,” “ignoring,” “reallocating,” “detecting,” “performing,” “polling,” “registering,” “monitoring,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such.

Embodiments described herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store one or more sets of instructions. The term “computer-readable medium” shall also be taken to include any medium that is capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details, such as examples of specific systems, components, methods, and so forth, in order to provide a good understanding of several embodiments of the present disclosure. It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A system comprising:
a memory; and
a processing device, operatively coupled to the memory, to:
receive, from a client device via a user interface, input data comprising an initial version of a machine learning model;
initialize an operating mode of the user interface for machine learning model building; and
generate an enhanced version of the machine learning model in accordance with the operating mode.

2. The system of claim 1, wherein the enhanced version of the machine learning model is generated based on an explanation indicative of feature importance.

3. The system of claim 2, wherein the explanation is a local interpretable model-agnostic explanation (LIME)-based explanation.

4. The system of claim 2, wherein, to generate the enhanced version of the machine learning model, the processing device is further to:
send the explanation to the client device;
receive, from the client device, user input relating to the explanation, wherein the user input comprises a set of ground truth features; and
generate the enhanced version of the machine learning model based on the user input relating to the explanation.

5. The system of claim 1, wherein, to generate the enhanced version of the machine learning model, the processing device is further to implement incremental learning.

6. The system of claim 5, wherein the incremental learning is regularization-based elastic weight consolidation (EWC) incremental learning.

7. The system of claim 1, wherein the processing device is further to:
generate a first evaluation of the initial version of the machine learning model; and
evaluate the enhanced version of the machine learning model by comparing the first evaluation to a second evaluation of the enhanced version of the machine learning model.

8. A method comprising:
receiving, by at least one processing device from a client device via a user interface, input data comprising an initial version of a machine learning model;
initializing, by the at least one processing, an operating mode of the user interface for machine learning model building; and
generating, by the at least one processing device based on the input data, an enhanced version of the machine learning model in accordance with the operating mode.

9. The method of claim 8, wherein the enhanced version of the machine learning model is generated based on an explanation indicative of feature importance.

10. The method of claim 9, wherein the explanation is a local interpretable model-agnostic explanation (LIME)-based explanation.

11. The method of claim 9, wherein generating the enhanced version of the machine learning model further comprises:
sending the explanation to the client device;
receiving, from the client device, user input relating to the explanation, wherein the user input comprises a set of ground truth features; and
generate the enhanced version of the machine learning model based on the user input relating to the explanation.

12. The method of claim 8, wherein generating the enhanced version of the machine learning model comprises implementing incremental learning.

13. The method of claim 12, wherein the incremental learning is regularization-based elastic weight consolidation (EWC) incremental learning.

14. The method of claim 8, further comprising:
generating, by the at least one processing device, a first evaluation of the initial version of the machine learning model; and
evaluating, by the at least one processing device, the enhanced version of the machine learning model by comparing the first evaluation to a second evaluation of the enhanced version of the machine learning model.

15. A non-transitory computer-readable storage medium comprising instructions that, when executed by a processing device, cause the processing device to:
receive, from a client device via a user interface, input data comprising an initial version of a machine learning model;
initialize an operating mode of the user interface for machine learning model building; and
generate an enhanced version of the machine learning model in accordance with the operating mode.

16. The non-transitory computer-readable storage medium of claim 15, wherein the enhanced version of the machine learning model is generated based on an explanation indicative of feature importance.

17. The non-transitory computer-readable storage medium of claim 16, wherein, to generate the enhanced version of the machine learning model, the processing device is further to:
send the explanation to the client device;
receive, from the client device, user input relating to the explanation, wherein the user input comprises a set of ground truth features; and
generate the enhanced version of the machine learning model based on the user input relating to the explanation.

18. The non-transitory computer-readable storage medium of claim 15, wherein, to generate the enhanced version of the machine learning model, the processing device is to implement incremental learning.

19. The non-transitory computer-readable storage medium of claim 18, wherein the incremental learning is regularization-based elastic weight consolidation (EWC) incremental learning.

20. The non-transitory computer-readable storage medium of claim 15, further comprising instructions that, when executed by the processing device, cause the processing device to:
generate a first evaluation of the initial version of the machine learning model; and
evaluate the enhanced version of the machine learning model by comparing the first evaluation to a second evaluation of the enhanced version of the machine learning model.
